(19) United States
(12) Patent Application Publication
(10) Pub. No.: US 2008/0275765 A1
(43) Pub. Date: Nov. 6, 2008

(54) CONFIGURABLE GIS DATA SYSTEM

(76) Inventor: EDWARD KUCHAR, BOISE, ID (US)

Correspondence Address: EDWARD J. KUCHAR, PO BOX 5537, BOISE, ID, 83705, US

(21) Appl. No.: 12/114,579

(22) Filed: May 2, 2008

Related U.S. Application Data
(60) Provisional application No. 60/928,053, filed on May 2, 2007.

(51) Int. Cl. G06Q 10/00

(52) U.S. Cl. 705/11

(57) ABSTRACT

A configurable GIS data system that spatially and temporally monitors personnel or material.

### CROSS-REFERENCE TO RELATED APPLICATIONS

This application is a non-provisional of and claims the priority date of the provisional application entitled CONFIGURABLE GIS DATA GATHERING TECHNOLOGY FOR TRIGGERABLE DEVICES SUCH AS: SPRAYERS, MOWERS, WEED-EATERS, METAL DETECTORS, AS WELL AS OPERATORS AND VEHICLES filed by Edward J. Kuchar on May 2, 2007 with application Ser. No. 60/928,053, the disclosure of which is hereby incorporated by reference.

### FIELD OF THE INVENTION

The invention relates to generally to an apparatus for the collection of task oriented data, and more particularly to the collection of vocational data as it relates to the monitoring of man-hours, consumable materials used, and tracking operational hours of equipment, and tracking spatial location of workers, equipment, and jobsites.

### BACKGROUND OF THE INVENTION

For a vast multitude of businesses and government entities, a considerable amount of time and man power is used to gather critical information about a job or task that is being conducted. This information can include, but is not limited to, the amount of consumable resources used on a job, man hours spent to complete the job, equipment hours used on the job, material asset location, gross vehicle hour for maintenance tracking. Additionally, in some work environments, it is necessary to log the physical location of an item or place of interest. This collected data is then reviewed and translated to various purposes, for instance, gathering the information necessary for such purposes as: historical record of activity, job performance evaluations, job management, automated reporting and incorporation with other GIS database information, communications between individuals and groups, and automated accounting and billing.

As well as requiring additional personnel and time, most of the tracking of this job related information depends on the integrity of the individuals reporting the information. One way to work around this common issue of the human condition is to have a member of management verify the data provided by employees, but this again relies on the individual and requires a larger investment of man power and valuable time.

The entire system of tracking and translating job related data requires an extensive amount of time and man power. What is needed is a way to automate the process and to take as much human reliance out of the process as possible.

A key need is the ability to both capture and provide the field information that is useful for this purpose. Possibly the most important reason for this technology is that it keeps track of things that are either difficult or impossible to see and communicate.

Validation is often essential, with this technology you can be sure the task has been completed and how. The inconvenience, difficulty, delay, and additional resources required to perform manual validation is reason enough to use technology where it makes sense. The incorporated technology allows for self monitoring, compliance monitoring and ease of validation; thereby saving a tremendous amount of time, money and effort. Moreover, in order to control anything, you have to be able to manage the data; management and decision making teams can benefit tremendously from the ability to automate this technology.

### SUMMARY OF THE INVENTION

One embodiment of the present invention is a configurable GIS data system that spatially and temporally monitors personnel and/or material. The system can keep track of job information such things as: task, machine, and operator. This applies to tasks personnel conduct such as: all spraying, fertilizing, chemical applications, riding mower operations, push mower operations, trimming, as well as the manual tasks they perform such as: raking, shoveling snow, and sweeping, as well as picking up things like: rocks, branches, and litter. The system is also capable of providing the information to answer questions such as: Did the operator do all that was expected? Was the entire job executed? How was the job executed? How was the equipment operated (i.e. speed)? Were excessive breaks taken? When did the operator arrive? When did operator depart? Who is doing the work? If a team of individuals is sent to a job; who did what and who are our best performers can be determined. Job appraisal, job accounting, job billing are all enabled and can be automated with this technology

This embodiment of the system is particularly useful on handheld and backpack-type spraying equipment or ATV spraying equipment; which includes spraying rigs mounted on ATV's, manually carried, and animal mounted. The system, by combining various technologies, provides a configurable system that provides the functionality to deal with this problem.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention.

As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 shows an embodiment of the logistical operation of the Configurable GIS Data System in flowchart diagram form.

FIG. 2 is system block diagram of an embodiment of the Configurable GIS Data System.

FIG. 3 is an operational diagram of an embodiment of the walker-positioner module of the Configurable GIS Data System.

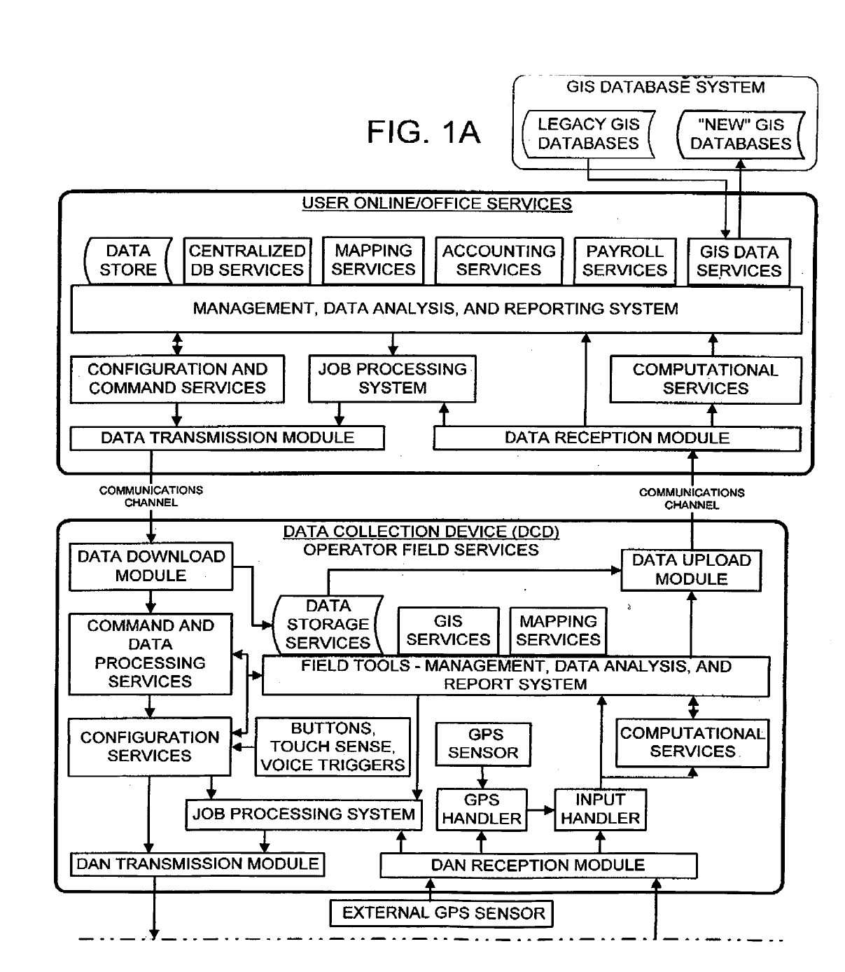

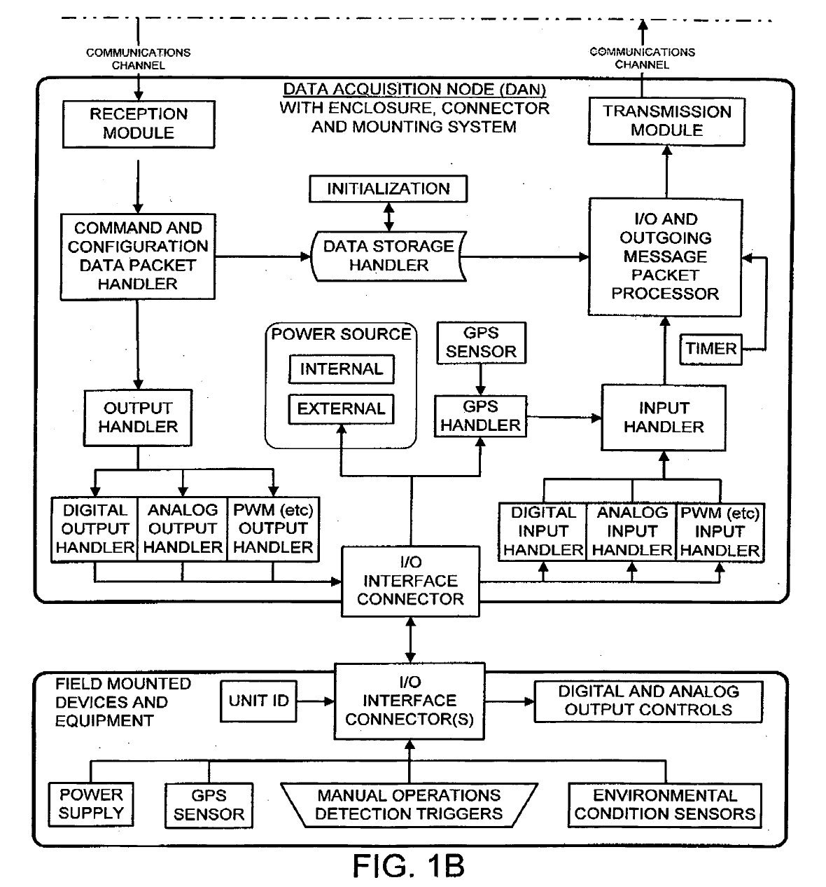

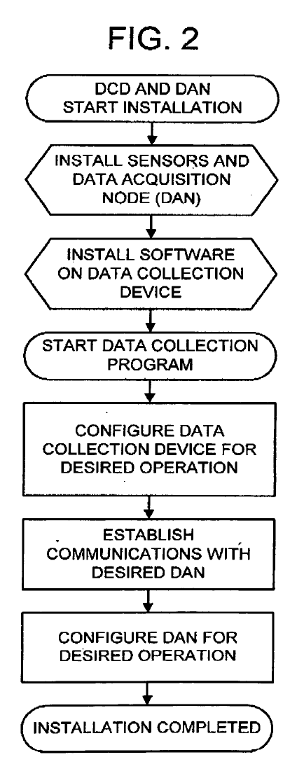

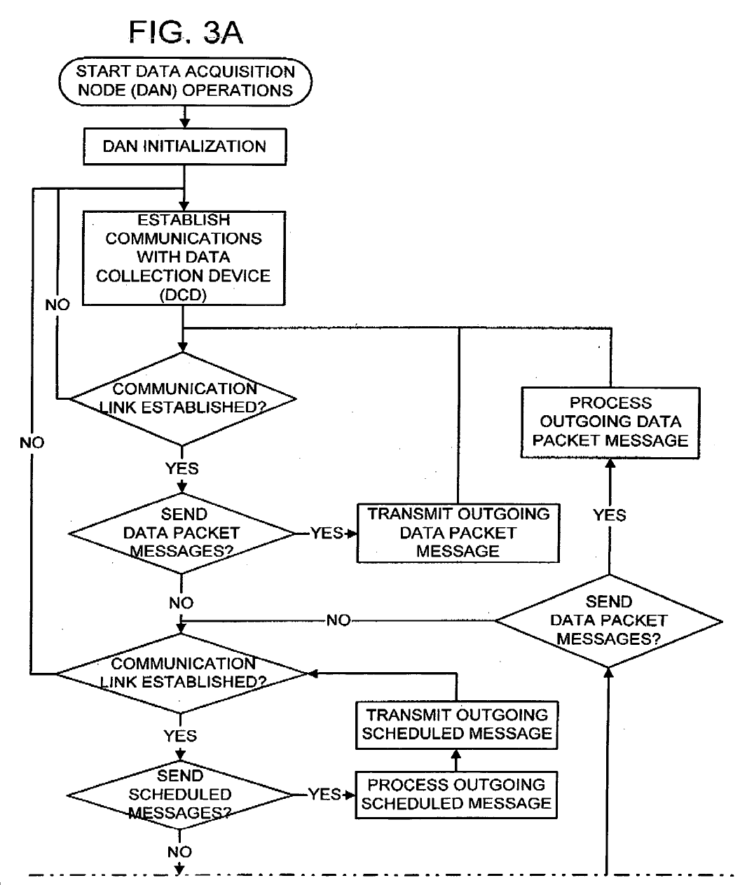

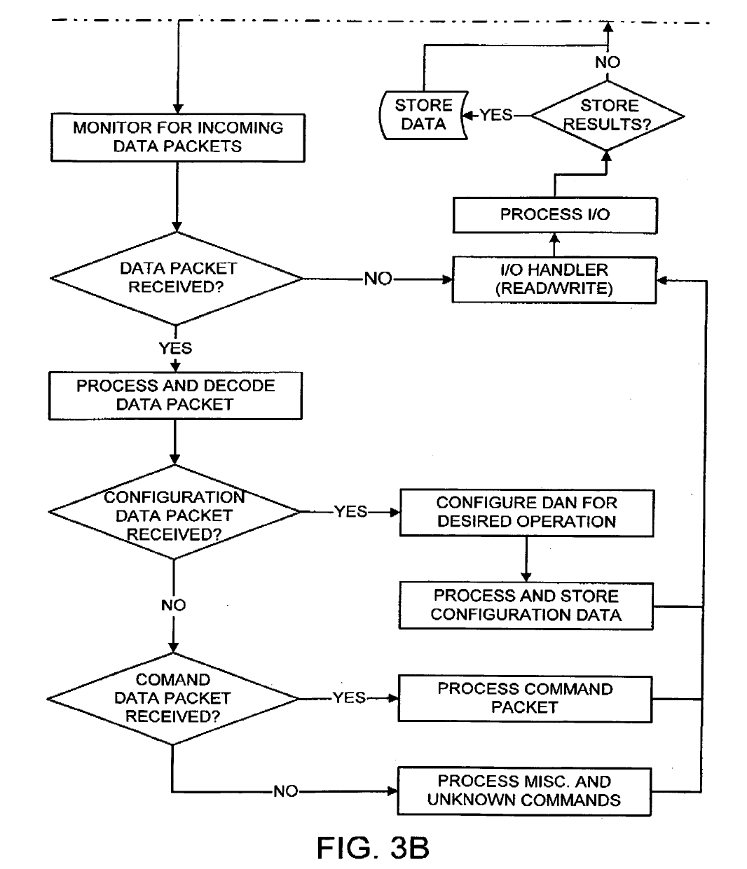

### DEFINITIONS

SOD—Self-Operating-Device—A device that provides automatic control of many of the functions (if not all) the device is capable of performing.

Operator—The individual who is “in the field” using the product.

User (Internet user)—The individual who is “in the office” using the products “gathered and downloaded” data.

GIS—Geographic Information System

GPS—Global Positioning System

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

The present invention is a configurable GIS data system and embodiments of this system are discussed herein.

In one embodiment, the configurable GIS data system (referred to herein as the “system,” “product” and/or “technology”) is used to acquire on the spot job related data especially in the area of triggerable devices (e.g., sprayers, mowers, weed trimmers, metal detectors, leaf blowers, snow blowers, roto-tillers), as well as their operators and the mode of transportation they are using. The system preferably includes the ability to get the acquired data out of the system and to an off-board location for later processing. This technology is also used in situations where no triggerable device involved.

A product based upon the system can be packaged in various “kit” configurations in order to meet the various needs and applications of the operators and users. A variety of differing input trigger sources can be used. All devices that have a triggering mechanism qualify for use with this product even if the trigger is remote from the trigger itself.

Off-the-shelf equipment is available for purchase to provide CPU functions, GPS, wireless communications, user interface and data gathering functions. Using PDA devices (e.g., BLACKBERRY®, PALM®) are expected to be the preferred configuration since they are readily available and are expected to provide great flexibility and cost advantages.

One of the primary goals of the system is to gather critical and/or valuable information about the job or task that is being conducted, for instance gathering the information necessary for such purposes as: historical record of activity, job performance evaluations, job management, automated reporting and incorporation with other GIS database information, communications between individuals and groups, and automated accounting and billing.

GIS and mapping tools provide real value, enabling those concerned and knowledgeable to be able to see historical events and results and hopefully enabling a clearer determination of more efficient decisions and solutions. One purpose behind the system and products employing the system described in this disclosure is to both capture and provide the field information that is useful for this purpose. Possibly the most important reason for this technology is that it keeps track of things that are either difficult or impossible to see and communicate. Validation is often essential, with this technology you can be sure the task has been completed (or not!) and how. The inconvenience, difficulty, delay, and additional resources required to perform manual validation is reason enough to use technology where it makes sense. The incorporated technology allows for self monitoring, compliance monitoring and ease of validation; thereby saving a tremendous amount of time, money and effort. Moreover, in order to control anything, you have to be able to manage the data. Management and decision making teams can benefit tremendously from the ability to automate this technology.

The system is also helpful with the removal of noxious weeds and at the same time keeping track of what was done.

The various components of the system can be mounted on a backpack sprayer itself and on the user for other operations. Note that in some applications a mount is not equipped; the mount is a possible configuration that is ergonomically effective and provides a method of carrying the “kit” components such as the computer, battery pack, and GPS/cell antennae equipment.

Some of the data gathering components will be connected onto the sprayer handle itself. There are many different configurations for different handles and pending on preferred locations for mounting the activation trigger and flow detection switches.

There is any number of sprayer configurations and handle sizes on the market that this technology can be adapted to. Because the installation “kit” for the particular make and model will need to “mount” onto the unit, each particular “kit” configuration may require different switch models or sizes. The preferred installation location for the “trigger” indication input is on or about the grip handle or trigger firing device. It is possible and may be found to be desirable to mount the trigger indicator or flow detection switch in another location. Triggers may actuate based on any operator/user selectable device. Some examples of these include engine starter switches, speed pickup switches, voice triggers, hardware based switches, computer touch screens, and PDA's.

There are many applications for lawn and garden type companies. For some individuals, such as those who are not good at paperwork and must therefore work for someone else, they can now be enabled, through the use of this technology, to have a significant portion of their paperwork automated. This technology has the potential to provide what is keeping them from owning and operating their own businesses.

Alternatively, one or more “modules” can be used with the system. The “Mile-Monitor” module is a user or operator configurable product intended to keep track of the use of a vehicle. But not just where you went. It is a product that can provide significant amount of useful information about the vehicles use such as: what is the vehicle that is being operated, where the vehicle went, who is operating the vehicle, what the job purpose/task is, as well as providing: computations, statistics, and reports for such things as: total mileage, total trips, sorted mileage by purpose (i.e. personal/business usages) and total operating time on the job. The Mile-Monitor is used for gathering such information as: the position of the vehicle being operated and when it was there. The data can be downloaded for analysis and reporting. It can also be used with other products described in this document such as connecting to devices that can be triggered.

The “Vehicular Use” module of the system is an essential tool for businesses, individuals who use their own personal vehicles for some job related tasks and individuals who run their own businesses and use their own personal vehicle as a “company truck.” This important tool allows a driver to simply switch a lever, push a button or activate any other input device back and forth from “Business Use” to “Personal Use” and back to “Business Use” again, at any time, over and over while driving. The result is that all the miles a person drives are compiled, sorted, recorded and reports are automatically created and downloaded to the individual, business or straight to the accountant, which ever you prefer and configure the tool to do. The data can be released in a timely intermittent fashion such as: daily, weekly, monthly, and annually. These reports are invaluable because they will be used for a number of important purposes. These are just a few examples; 1) tax deductions for the business miles used on your personal vehicle, 2) reimbursement of business miles driven on your personal vehicle by your employer, 4) timely expense reports turned in to employers, 5) monitoring by employers of their employee's performance, honesty and efficiency in their delivery routes, and 6) comparing performance and care of company vehicles among operators and so on. The result is that all the miles a person drives can be compiled, sorted, recorded and reports automatically created, downloaded to the individual, business or straight to the accountant.

In addition to the extremely useful feature that the Vehicle Use module provides in the way of reports at the end of a certain specified time frame (i.e., daily, weekly, monthly, annual) it has the distinctive ability to reveal to an authorized viewer (employer, parent, police, etc.) over the Internet, the current location of a vehicle in question in the event of an issue regarding customer satisfaction, to monitor job progress and expected completion time and any other concern that a person or employer may consider applicable to their needs. In addition to all of these ideas that may aid in the increased profitability of a business there is also another, very benevolent aspect of being able to locate a particular vehicle or employee in the unfortunate event of an accident or even in the theft of a vehicle.

This device can be installed onto (interfaced with) automobiles, pickup trucks, four wheelers, ATVs, helicopters, airplanes, military vehicles, tanks, locomotives, garbage trucks, dump trucks, back-hoes, construction vehicles (e.g. scrapers, cranes, wheel loaders, graders, cement mixers, farm tractors, windrowers, lawn mowers, semi-trucks, ambulance, fire truck, municipal and utility vehicles).

The system can also be incorporated into other automated devices, not only to manually operated devices.

In one embodiment, the Mile-Monitor module can record, but is not limited to, the following data: location . . . keeps track of where the unit went; time and date; ambient temperature; ambient humidity; battery voltages; and operational data (e.g., motor rotation, motor power).

In another embodiment, the Mile-Monitor module can have, but is not limited to, the following indicators: activated . . . “Mile-Monitor” is recording; battery voltage condition; trigger switch activation—red/green? indication for switch inputs; trigger tone—acknowledgement of “activation and trigger”; red/green occupational (job defined boundaries and specific locations) zone control indicator (optional); and alarm/notification indicators.

In another embodiment, the Mile-Monitor module can have, but is not limited to, the following interfaces: powered by vehicle power or battery power; digital input indicators; analog input signals; engine “in-operation” monitoring; time and date; GPS—location/speed; download to GIS and mapping systems; user interface module (display); user interface module (push button/keypad); and digital inputs—(selection/configuration).

In another embodiment, the Mile-Monitor module can have, but is not limited to, the following configurations: identification of trespass out of defined work zones; controller for operation in defined work zones; selection of the operator? LOGON/Operator Validation (allow the individual using the equipment to identify themselves); corporate, individual (service provided by selector); generals (corporation), colonels (franchises/company), captains (location/branch), managers (field supervisors), contractors, private (management level validation selector), operators; and “Personal/Business Use” or general vehicle operations.

In another embodiment, the Mile-Monitor module can be used for, but is not limited to, the following applications: integrate into GIS systems—mapping and review systems; joint information between all of the various concerned groups: corporate, franchise or company, location or branch, private land owners, individuals, operators, etc.; information for the workforce to enable them to demonstrate the work completed (accountability information); automated tax reports, accounting and billing systems; all sent to the people who need them; length of operation (how long was the unit operated); “Personal/Business Use” of a vehicle; replaces log books and provides more detailed reports.

During operation, the Mile-Monitor module keeps track of the time, date, and changing position of the vehicle, with GPS accuracy. The operator is allowed to provide input which can change the current configuration and provide input to specify the current operational mode. Gathered information is stored and can be downloaded for user access.

The Mile-Monitor module could be used on school buses. In certain “kit” configurations the routes, stops and student pickup locations can all be configured.

The Mile-Monitor module can be used for public transit operations. In certain “kit” configurations the routes, stops, and locations for picking up the patrons can be identified.

Lawn care professionals can keep track of a tremendous amount of information about their jobs. For example, the mowing done by each individual lawn mower (can compute life span and maintenance history for the machine since the operational history is maintained). This device will keep track of where and when an operator entered a given property. Furthermore, it will keep track of where this individual went while on the property. This has significant application potential; monitoring situations where certain properties contain highly sensitive areas that need to be protected against intrusion. A report or external alarm, can via the internet, of the intrusion can be generated from the gathered data and sent to concerned users.

This device will keep track of where and when an operator exited a given area. A report or external alarm, say via the Internet, can be generated from the gathered data and sent to concerned users (possibly parents).

The Mile-Monitor module provides proof the job was conducted. The Mile-Monitor module can be configured to provide a substantial amount of information about the vehicles use, therefore, such things as: improved job analysis, reporting, and automated accounting and billing functions can be performed.

For applications that require vehicular tracking the Mile-Monitor module of the configurable GIS data system provides the automated recording of vehicle usage. The Mile-Monitor module can be configured to be used as a “Personal/Business Use” device. Once in this configuration the user selects the use type via an input switch. The Mile-Monitor module makes sure all of the data is downloaded off the vehicle, placed on a server, is available on the internet, and is available for reports. For this customer, the information necessary for automated monthly reports such as: usage reports and tax reports, is available.

This Mile-Marker module can also be configured for a number of other “vehicular uses” such as: construction equipment, riding lawn mowers, and ATV's. The Mile-Marker module can be configured so that the “vehicle” can actually be the operator. Knowing the vehicles use helps enable such things as: job analysis, automated job accounting and billing.

Other embodiments of the present invention may have other modes (or “modules”), such as the “Sniper mode,” the “Walker mode,” the “Spotter mode,” or the “Positioner mode.”

The Walker/Positioner module is a user or operator configurable product used for tasks such as: getting the operator to a desired (starting) location, pacing the operator, and keep track of where the operator has walked and identifies where the operator should walk next. During operation, the operator can switch between “Walker” and “Positioner” modes.

The “Walker/Positioner” is a proposed SOD device that enables the automated use of recorded position/location information, in an intelligent manner; to enable the user to go to a specific position, say where he quit yesterday, and to continue in a pattern that notifies the user of overlaps and gaps in coverage. This device keeps track of where they have been, gets them back to a specific position for starting up (such as where they last ran out of spray) and to direct their steps in such a way as to align them to previous work done in order to avoid both overlaps in coverage and gaps in coverage. Obviously, it is still up to the operator to conduct his own movement. The “Walker/Positioner” can be configured for such things as operator identification, swath direction, swath width, object identification. Swath width is used to identify gaps in coverage. During validation efforts the “Walker/Positioner” can direct the operator's movement to these gaps in coverage, since these are likely locations in which it is desirable to see if in reality there were no objects being validated.

The effectiveness and quality of the application can be recorded via the “Walker/Positioner” module. Performance evaluations/validation can also be accomplished using the data logged by this device. This device can be used entirely independently of those other tools. This tool allows for the monitoring of such user actions as for example, you would find in a lawn care operation going out and raking leaves, where in this case there is nothing to “trigger,” just record the fact that the individual went to the job site and when. This information can then be used for such things as automated accounting and billing.

It is highly desirable that the unit be small and light! The “Walker/Positioner” module can be used in conjunction with a “Sniper” module to allow for the treatment of plants not previously treated (i.e. treatment applied if no previous treatment occurred).

In another embodiment, the Walker/Positioner module uses a similar power source and a user interface which notifies, confirms and alerts the user via color coded graphical interface (e.g. LED's, displays, indicators), audio signals and/or GPS mapping display units as to the current path he is on and which can guide him to a specific location to either continue with a previous task or find a place which needs some sort of attention.

In an other embodiment, the Walker/Positioner module can record, but is not limited to, the following data: location . . . keeps track of where the operator/equipment went (i.e. keeps track of where the operator walked or took his four-wheeler or vehicle); time and date; digital inputs—triggered mark point (or return to location), selection/configuration of what is being validated (i.e. weed selection/configuration); swath widths; operator movement is recorded so that an area traversed can be identified. this allows us to detect overlap and gaps; battery voltages.

In another embodiment, the Walker/Positioner module can have, but is not limited to, the following indicators: activated . . . “Walker/Positioner” is recording; battery voltage condition (green/red LED or meter); trigger switch activation—red/green? indication when being fired; trigger tone—acknowledgement of “activation and trigger”; red/green environmental and occupational (political and job defined boundaries) zone control indicator (optional); s graphical interface to show the user the current position within a swath.

In another embodiment, the Walker/Positioner module can have, but is not limited to, the following interfaces: powered by vehicle power or battery power; GPS; download to GIS and mapping systems; other sensors/switches/indicators are built into the “Walker/Positioner” kit; LED light bar or series of green/red light indicators to show relative postion within a defined swath; touch screen interface; deypad/trigger input (BLACKBERRY®, IPOD®/PALM PILOT® style interface); digital inputs (unit selector/configurations/trigger etc.); Walker/Positioner mounting unit (backpack strap on device to enable the unit to move freely with the operator); and audible alarm or speakers.

In another embodiment, the Walker/Positioner module can have, but is not limited to, the following configurations: selection of Positioner (getting into position) or Walker (keeping on track) modes; identification of trespass into environmental zones; controller for operation in defined environmental zones; selection of the operator? LOGON/Operator Validation (allow the individual using the equipment to identify themselves); Federal, State, County, Township, District, Individual (service provided by selector); group selector—BLM, FS, F&G, etc., rancher, farmer, corporate, individual, volunteer, scientist (player selector); generals (Federal), colonels (States), captains (county extension), managers (field supervisors), contractors, and private (management level validation selector).

In another embodiment, the Walker/Positioner module can be used for, but is not limited to, the following applications: integrate into GIS systems—mapping and review systems—war-on-weeds type information access; Joint information between all of the various concerned groups: EPA, USDA, BLM, FS, F&G, Federal list, State list, County Extension Agents, private land owners, the Monsanto's of the world, scientists, field applicators, universities, weed management agencies, libraries, individuals, etc; joint information for Health and Human Services, environmental concerns, etc.—to provide joint cooperation between all affected groups; data for the government and commercial to analyze spray effectiveness of the various conditions in which the sprays were applied; information for the workforce to enable them to demonstrate the work completed (accountability information); and automated accounting and billing capabilities.

In “Positioner” mode the operator will be directed to a particular desired location. Using information on the desired location and the current operator location and direction, where the operator should go can be displayed.

In “Walker” mode the position of the operator will be displayed and what surrounds the user will be identified. Using adjoining boundaries or previous swath information and where the operator previously walked the desired operator position can be computed. The operator's position and surroundings will continually be updated on the display.

During operation the Walker-Positioner continually reports the time, date, and the operator's location, with GPS accuracy. Movement information is stored and can be downloaded for user access. Initialization of the desired points to go to, as well as provide boundaries for areas, can be simplified if information is available from previous activities such as previous: “Sniper,” “Mapper,” “Spotter,” “Snipper,” and “Validator” activities.

This device will keep track of where and when an operator entered a given property. Furthermore, it will keep track of where this individual went while on the property. This has significant application potential; monitoring situations where certain properties contain highly sensitive areas that need to be protected against intrusion. A report or external alarm, say via the internet, of the intrusion can be generated from the gathered data and sent to concerned users.

The Walker-Positioner can be used both as a stand-alone and an add-on functionality product that provides pacer and spacer/placer functionality. Efficiencies can be gained by communicating to the operator what is done and what has not yet been done; the “Walker” mode helps prevent such things as gaps and overlaps. Task or job performance evaluations and analysis can be made using this product.

The Walker-Positioner can also be configured to provide a substantial amount of information about the job/task, therefore, such things as: improved job analysis, reporting, and automated accounting and billing functions can be performed.

The Walker-Position product can be used independently of all of the other products in this line. There is a significant advantage to this. For example, consider a commercial lawn care environment where someone is hired to rake up and remove leaves from a particular property. A rake does not have to be “triggered” but it would be useful to monitor and know someone showed up and went to the area where the leaves were. This device will keep track of this information and can be used for later proof of when the job was conducted as well as provide the information needed for automated job accounting and billing.

The Walker-Positioner can be uses on school buses. The route and the student pickup locations can all be identified. The Walker-Positioner can be used for public transit operations. The route and locations for picking up the riders can be identified.

Choosing “Positioner” mode is used to set-up the system to direct you to a particular location. In this mode, the operator is directed to the desired location via a lone LED (or whatever display device is chosen for the product). A really nice way to do this in the future is to have a graphic display showing areas that were not processed and to select the desired place to go using a touch screen. Once there, enable the “Walker” mode. The desired swath width can be set and the area can be processed or validated; the configuration manual shows how to both choose the mode of transportation and configuration of the swath width. The provided “Preferred Walker-Positioner LED Direction and Swath Indicator Bar” diagram provides a number of scenarios illustrating how the device works. An input or toggle switch, permanently installed on the unit, could be used to swap between “Positioner” and “Walker” modes.

One way to define and setup the initial operating conditions is to set the “Boundary Marks” prior to execution of swaths. Another method of initialization is to configure a narrow swath width, execute it, possibly even mark the endpoints of the swath, and then use this as a reference for the remainder of the swaths to be executed next to it; all in succession. All previous swath executions are recalled, for example, where you left off yesterday. Go to where you left off, or ran out of spray for example by going into “Positioner” mode because it provides the function of leading you to the desired position.

Once the data is downloaded it is available for user access. Proper permissions and access capabilities allow the data to be accessed. The data can be processed into reports to meet the user's needs. Report delivery can also be automated via the Internet.

This product is designed to provide information about the task completed such that features such as: automated accounting, payroll, accounts payable/receivable can be added by using GIS databases to further enhance the gathered data. The collected data can be used to provide a number of useful results for the users such as: creating technical and statistical reports, contributing to GIS databases, mapping of the data, and satellite images of the locations where the data was captured.

The information provided by the operator during configuration can also be provided by the user using a desktop computer. The various input changes that occur during operator configuration are downloaded. It is possible for the user to override the operator configuration or provide the proper configuration directly if so desired, both before and after the data was actually captured. The base options available are determined by the “kit” ordered. The user is entitled to create their own definitions, however, it is then up to these users to provide this information for the operator to be able to properly configure the product. The configuration information provided to the operator must correspond to the definitions used when processing the downloaded data. After the data is gathered and downloaded, the operator's configuration may be adjusted by users with the appropriate authority.

The Sniper module is a user or operator configurable product used for tasks such as spraying. For this application an operator uses the sniper module. The “Sniper” is a proposed SOD device that enables the automated recording of information for managers, scientists, or regulators, etc. The “Sniper” is a device used to record spraying in an intelligent manner.

This device can be installed onto (interfaced with) backpack spray units, four wheeler spray units, etc. It is highly desirable that the unit be small and light. If the operator is already carrying a load of spray, they do not want to have to carry anything more.

The Sniper module records a multitude of various data types such as; Location or “Walking Path” . . . keeps track of where the unit went (i.e. keeps track of where the “Sniper” operator walked or took his four-wheeler), Time and Date, Ambient Temperature, Ambient Humidity, Tank pressure, Wind velocity and direction, Battery voltages, Length of spray (how long was the unit triggered), Change in location of the spray head during triggering (i.e. was a patch being sprayed or was an individual plant being sprayed), when GPS is attached to the spray head, Spray type, weed selection, and Flow switch actuation.

In an embodiment the Sniper module also has attached the following indicators: Activated . . . “Sniper” is recording, Battery voltage condition (green/red indication or meter), Trigger switch activation—red/green indication when being fired, Trigger tone—acknowledgement of “activation and trigger”, Red/green environmental and occupational (political and job defined boundaries), and zone control indicator. Zones variation/modifications can occur under proper conditions and granted permissions. For example, distances from streams can be either reduced or increased based upon wind speed and direction. Wind speed alone can and most likely should be used to prevent sniper activation, “Walking path” LED bar positioning on walking path (optional). Outside LED indicators can be RED indicating that coverage area is being duplicated.

Further the Sniper is preferably powered by vehicle power or battery power and contains; Sprayer handle activation switch, at least one pressure source (Tank, etc.), at least one humidity sensor, temperature sensor, flow meter(s) and/or flow switches, wind sensors, time and date indicators, GPS(s)—multiple locations for mounting.

The Sniper module can preferably download to GIS and mapping systems and integrates with computer hardware to achieve this.

An alternate embodiment of the sniper has a built in pump and other sensors/switches/indicators are built into the “Sniper” kit.

The operator uses hand (mechanical) operated triggers and/or voice operated triggers in another embodiment. The operator uses displays, LED or display indicators, and sound (tone) emitting devices to determine the various states of the apparatus.

Computers (i.e. BLACKBERRY®, IPOD®, PALM PILOT®, Pocket PC, AutoPC, custom hardware, PDA's, etc.—be compatible with equipment which is likely already available) and software add-on products to enable the equipment to work as a system are included in some embodiments.

Incorporation of the system can be used in other products, some of these are, Leaf blowers, weed trimmers, employee monitoring (e.g., jobs that need to be completed). Also it will provide the ability to analyze the coverage paths to allow managers to review employee and job satisfaction; eliminate costs associated with going back out to review something that may even be impossible to review at a later date

There are many configurations of the Sniper module. Some of these configurations are; Selection of the spray (or fertilizer) being used (sprays list and/or fertilizer lists), Selection of the weed type(s) being treated (weeds list), Selection of the size of the weed being treated (rosette/mature) (weed size selector), Identification of trespass into environmental zones; controller for operation in defined environmental zones, Selection of the operator? LOGON/Operator Validation (allow the individual using the equipment to identify themselves), Sniper list (i.e. backpack unit, four-wheeler unit, spotter, mapper, validator, etc.), Federal, State, County, Township, District, Individual (service provided by selector), Group selector for indication authority control levels—BLM, FS, F&G, etc., rancher, farmer, corporate, individual, volunteer, scientist (player selector), WAR-ON-WEEDS information: Generals(feds), colonels(states), captains(county extension), managers(field supervisors), contractors, private (management level validation selector), Use off-the-shelf hardware and software products where available (as long as they are a feasible solution).

As well as multiple configurations, the Sniper module can be used in many applications, some of these applications are; Provide service for lawn care companies (LCC) to better keep track of quality control; Keep track of applications for companies such as ChemLawn etc.; Integrate into GIS systems, as well as other, mapping and review systems; Joint information between all of the various concerned groups: EPA, USDA, BLM, FS, F&G, Federal list, State list, County Extension Agents, private land owners, the Monsanto's of the world, scientists, field applicators, universities, weed management agencies, libraries, individuals, etc.; Joint information for Health and Human Services, environmental concerns, etc.—to provide joint cooperation between all affected groups; Data for the government and commercial scientists to analyze spray effectiveness of the various conditions in which the sprays were applied; Determination of effectiveness of previous and continuous treatments. For example, if treatments are conducted over a number of years—are improvements being realized? Prolonged (multi-year) effect analysis; Ability to audit (individuals and project) work; Regulatory validation to keep sub-contractors honest; Information for the workforce to enable them to demonstrate the work completed (accountability information).

Other embodiments include communication between “Sniper” units so that if someone sprayed a plant the next operator to come along would not be allowed to provide a secondary application. Additionally control spray activation and quantities such as: disabling spray applications near steams and not allowing excessive amounts of spray to be applied to individual plants.

During operation, the Sniper automatically marks the location, with GPS accuracy, where and when spray (or whatever) was applied. A Sniper “Kit” can also include such functionality as: positive “application detecting” (i.e. fluid flow in sprayer applications), gathering environmental conditions and making calculations. See the Sniper “data sheet” for additional details. The gathered information is stored and can then be downloaded for user access. The Sniper can also be switched into “Spotter” mode.

The Sniper module is needed for applications such as noxious weed control, a number of agencies currently record the work that is conducted manually. This technology will allow automation of this task and is projected to provide much greater accuracy and detail; while at the same time the operator is getting the work done.

It is anticipated that much more work can be accomplished using the same number of resources since there will no longer be a need to do some of the manual tasks that are currently necessary.

The unit can also be configured to provide a substantial amount of information about the job/task, therefore, such things as: improved job analysis, reporting, and automated accounting and billing functions can be performed. A wide range of users can benefit from the gathered data.

Each time the Sniper is triggered, accurate location information is captured, therefore, accurate locations, computations such as: densities and acreage, as well as, mapping can be provided automatically.

The Sniper can be used in conjunction with the Walker/Positioner functionality. This configuration is useful for situations in which the “tank” has been emptied, but the job is not yet complete, or if it is desirable to conduct such activities as “Mapping” or “Spotting” prior to leaving the current work location. In these cases, task validation is simplified and in some cases automated.

The “Spotter” is a proposed SOD device that enables the automated recording of information for managers, scientists, etc. related to the relative location of something that is observed and desirable to record. The “Spotter” is a device used to record something that you spotted (saw) and want to record its location (for instance via distance and/or GIS ownership) in an intelligent manner.

One example of how the spotter might be used is this. An individual (who can be configured for the use of the spotter) is driving down a country road and “spots” some noxious weeds in the road ditch and just across the fence on private land. He stops on the side of the road and if the unit is not already configured for the specific noxious weeds he sees, he configures the unit for the identified weed type. Using the left and right input selections, the side of the road the weeds are on can be identified (both sides will be selected if weeds are on both sides of the road).

Pressing the directional buttons once can indicate that the weeds are in the road ditch. Pressing the directional indication once again can indicate that the weeds are just across the fence. In addition, further input indications can identify that the weeds extend out into the distance. The information provided by the spotter can represent an individual's personal meaning (relative to whatever it might mean to their particular needs) behind the spotter inputs. This information can further be used to automate the production of reports/letters to be sent out to the individual landowners to notify them of the fact that the weeds exist on their property.

This device can be installed onto (interfaced with) vehicular units, such as pickup trucks, four wheelers, locomotives, airplanes, as well as, incorporated into battery powered units that can be mounted on such things as backpack units or mounted on an individual or animal.

This device can be a touch screen that has a dot in a center location (i.e. representing where the vehicle currently is. From there the operator can use the touch screen interface to select what was spotted and how far away from the present location to what was spotted. The touch screen should also display N/S/E/W for the user to enable directional selection to the spotted item.

During operation the device not only gathers data but allows the operator to configure the mode of operation.

The spotter does not have to be used to record weed locations only. It can be used to register the location of potential jobs applicable to the lawn care applications. Wildlife sighting and recording, tree locations, void locations, fence locations, property boundaries are other examples of things whose position can be recorded.

Another embodiment the Spotter module can record, but is not limited to, the following data: Location . . . keeps track of where the unit was when the spotting occurred; Time and Date; Spotted location identification; Identification of what was spotted; Digital input selection/configuration; Battery voltages

Another embodiment the Spotter module can have, but is not limited to the follow indicators: Activated . . . “Spotter” is recording; Battery voltage condition (red/green indicator or meter); Touch screen activation and location selector or BLACKBERRY®, IPOD® type input controls—red/green? indication when being fired; Trigger tone—acknowledgement of “activation and trigger”.

Another embodiment the Spotter module can have, but is not limited to the following interfaces: Powered by vehicle power or battery power; Spotter trigger switch(s)—such as left, right, activated (spotter mode selection); Digital inputs selection of what was spotted, the user identification; Time and date; GPS position; Download to GIS and mapping systems; Other sensors/switches/indicators are built into the “Sniper” kit; which this “Spotter” kit adds on to; Touch screen interface; Keypad or BLACKBERRY®, IPOD® input type controls; Digital input selection/configuration.

Another embodiment the Spotter module can have, but is not limited to the following configurations: Selection/configuration of the object being selected; Identification of trespass into environmental zones; controller for operation in defined environmental zones (GIS system interface). Identify object as being in an environmental zone; Selection of the operator? LOGON/Operator Validation (allow the individual using the equipment to identify themselves); Spotter list (i.e. pickup trucks, four wheelers, locomotives, airplanes, as well as, incorporated into battery powered units that can be mounted on such things as backpack units or mounted on an individual or animal.); Federal, State, County, Township, District, Individual (service provided by selector); Group selector—BLM, FS, F&G, etc., rancher, farmer, corporate, individual, volunteer, scientist (player selector); Generals (Federal), colonels (States), captains (county extension), managers (field supervisors), contractors, and private (management level validation selector).

Another embodiment the Spotter module can be used, but is not limited to the following applications: Integrate into GIS systems—mapping and review systems; Joint information between all of the various concerned groups: EPA, USDA, BLM, FS, F&G, Federal list, State list, County Extension Agents, private land owners, the Monsanto's of the world, scientists, field applicators, universities, weed management agencies, libraries, individuals, etc.; Joint information for Health and Human Services, environmental concerns, etc.—to provide joint cooperation between all affected groups; Data for the government and commercial scientists to analyze spray effectiveness of the various conditions in which the sprays were applied. Are weeds being spotted in previously treated areas? How long has it been since last treatment occurred (i.e. determine if previous treatment was effective)? If later spotting (was previous work effective) spotter can be used as a validator; Information for the workforce to enable them to demonstrate the work completed (accountability information); Determination of effectiveness of previous and continuous treatments. For example, if treatments are conducted over a number of years—are improvements being realized; Identification of spotter (ID # of spotter having recorded the data); Automated notifications.

A user or operator configurable product used for tasks such as identifying “relative” locations of observed objects is the spotter module. Models can be ordered with pre-defined variations, depending on which add-on selection best suits the users needs such as: war-on-weeds, lawn care, range and ranch, construction, recreation, wildlife management, municipalities, trucking and trains, delivery, vehicular use, people and police, waste and litter, streams and lakes, and generic. In order to meet unique user needs much of the configurable information can be modified. Starting from the operator's current location, with GPS accuracy, the operator proceeds to specify the “relative” direction, quantity or size, and distance to the object(s). See the Spotter “data sheet” for additional details for functionality you might find in a Spotter “kit”. The gathered information is stored and can then be downloaded for user access. The Spotter can also be switched into “Sniper” mode or be configured for other uses such as: monitoring vehicular use.

The spotter module is a preferred module since it is not always possible to map every observed object occurrence, the “Spotter” provides, in “relative” accuracy and detail, an identification of where something is. In this way a note of the occurrence is recorded and this information can be provided to users who find this information useful. Makes tasks such as the “war-on-weeds” somewhat more efficient. The current methods of documenting observed weed infestations can be more efficient. The Spotter can automatically compile the information gathered and communicate it to a wider audience of users. Spotting is a “relative” form of mapping. Areas that need to be followed up on are identified and recorded. Spotter functionality can be incorporated with other functions such as: Sniper, Validator, Vehicular Use and “Walker/Positioner” functionality. The unit can also be configured to provide a substantial amount of information about what was “spotted”, therefore, such things as: automated notifications, reporting, and communication functions can be performed.

The Mapper module is a user or operator configurable product used for tasks such as marking the location of an object or other point of interest and patch/area boundary points. During operation the Mapper marks the location of points identified by the operator, with GPS accuracy, and the time and date it was marked; these points may be configured to be boundary points. When identifying patches or areas only the points on the perimeter need to be identified. The Mapper records these points, makes calculations such as: areas and historical patch size changes, creates maps, and communicates this information to users. See the Mapper “data sheet” for additional details. The gathered information is stored and can then be downloaded for user access. The Mapper can also be switched into “Spotter” mode.

The Mapper marks the location of where something is and allows for subsequent treatment and analysis (i.e. the removal of or spread of what is being treated). In applications such as noxious weed control this is already considered an important task. The Mapper uses technology to provide a solid foundation for quickly gathering, recording, compiling reports and maps, and communication of this information to the users. It may be out of season for treatment/application, but it would be useful for next year if a person knew where the weeds were. Use the Mapper to accomplish this. A Mapper can be sent out with campers or enthusiasts into wilderness areas under the condition they are not certified to apply chemicals. While in these areas, individuals can identify and record such information as the vegetation types in the area, thereby, helping determine the locations of such things as noxious weeds. Follow up can be made using a combination of other product(s) and features: “Walker-Positioner,” “Sniper,” “Spotter,” “Validator,” or even a “Snipper”. The unit can also be configured to provide a substantial amount of information about the job/task, therefore, such things as: estimated task and resource analysis, reporting, and communication functions can be performed. Mapper marks the location of where something is. This can happen at the same time an application/task is being accomplished. An example of a use of a mapper when an application is not being applied is when say some weeds may be out of season for treatment but it would be useful for next year if a person knew where the weeds were. This unit can be sent out with campers and enthusiasts etc. into wilderness areas. While in these areas the campers etc. can record the vegetation types in the area; thereby helping determine the locations of noxious weeds; which later can be treated with the “Sniper”. Notice that the Spotter differs from the Mapper (and Sniper for that matter) in that the Spotter identifies a relative location from the current GPS location and the Sniper, Mapper, and Validator provide localized “pin-pointed” location information.

The “Mapper” is a proposed SOD device that enables the automated recording of information for managers, scientists, etc., those individuals interested in the information. The “Mapper” is a device used to record areas that you want to record its location for later treatment . . . in an intelligent manner.

This device can be installed onto (interfaced with) vehicular units, such as pickup trucks, four wheelers, locomotives, airplanes, as well as, incorporated into battery powered units that can be mounted on such things as backpack units or mounted on an individual or animal.

This device can be a touch screen or the press of a button that determines either the center of a location or as a marker used to determine the boundary of an area. “Mapper” can also be used as a tool to break a mapped area into smaller segments in order to enable multiple map segments to be traversed in a later treatment.

The “Mapper” is a device that is handy for persons who are not properly certified for operating a “Sniper” to be enabled to gather data relative to weeds/object locations to support those who will later come in to treat a given area.

The “Mapper” does not have to be used to record weed locations only. It can be used to register the location of potential objects and obstacles applicable to the Lawn Care applications for example.

Another embodiment the Mapper module can record, but is not limited to, the following data: Location . . . keeps track of where the unit was when the mapping occurred; Time and Date; Mapped location identification; Digital selection/configuration inputs (indicator of what is being mapped); Battery voltages.

Another embodiment the Mapper module can have, but is not limited to, the following indicators: Activated . . . “Mapper” is recording; Battery voltage condition; Trigger button; Touch screen activation and location selector—red/green? indication when being fired; Trigger tone—acknowledgement of “activation and trigger.”

Another embodiment the Mapper module can have, but is not limited to, the following interfaces: Powered by vehicle power or battery power; “Mapper” trigger (only Blackberrys, IPOD type device and digital type inputs for example); GIS system (internet access) download capabilities; Computer and GPS equipment; Other sensors/switches/indicators are built into the “Mapper” kit; Touch screen interface; Keypad/trigger input; Digital inputs (user enabled selection/configuration/activation).

Another embodiment the Mapper module can have, but is not limited to, the following configurations: Selection of the object being selected (weed list/tree list/object list); Type of data being recorded and whether or not the data is related to other captured data points; Identification of trespass into environmental zones; controller for operation in defined environmental zones; Selection of the operator? LOGON/Operator Validation (allow the individual using the equipment to identify themselves); Spotter list (i.e. backpack unit, four-wheeler unit, pickup trucks, four wheelers, locomotives, airplanes, as well as, incorporated into battery powered units that can be mounted on such things as backpack units or mounted on an individual or animal.); Federal, State, County, Township, District, Individual (service provided by selector); Group selector—BLM, FS, F&G, etc., rancher, farmer, corporate, individual, volunteer, scientist (player selector); Generals (feds), colonels (states), captains (county extension), managers (field supervisors), contractors, private (management level validation selector).

Another embodiment the Mapper module can be used in, but is not limited to, the following applications: Integrate into GIS systems—mapping and review systems; Joint information between all of the various concerned groups: EPA, USDA, BLM, FS, F&G, Federal list, State list, County Extension Agents, private land owners, the Monsanto's of the world, scientists, field applicators, universities, weed management agencies, libraries, individuals, etc; Joint information for Health and Human Services, environmental concerns, etc.—to provide joint cooperation between all affected groups; Data for the government and commercial scientists to analyze spray effectiveness of the various conditions in which the sprays were applied. This is for those conditions in which the area was previously treated and the “Mapper” is being used to identify areas in which there are no longer weeds or identify those areas that were treated where weeds still exist. Determination of effectiveness of previous and continuous treatments. For example, if treatments are conducted over a number of years—are improvements being realized?; Information for the workforce to enable them to demonstrate the work completed (accountability information) (i.e. identifies the areas traversed, mapped, etc.) so that they can show that they actually did what was expected of them. Was the contract executed?

The Validator module is a user or operator configurable product used for tasks such as validation of work performed; the Validator is used at some point in time (after the initial treatment) to review for missed or ineffective applications.

The “Validator” is a proposed SOD device that enables the automated recording of information used to record, in an intelligent manner, the effectiveness of an area previously treated. It is also used as a tool to confirm that the validation was conducted. This product is a subset of a “sniper” and provides a similar function, but is usually used by an entirely different group of individuals with a different set of goals. This device is used to specifically identify/determine whether or not particular weeds had previously been treated. This allows managers to analyze the effectiveness of those providing a previous treatment. Performance evaluations/validation can also be accomplished using logged ‘Sniper’ data.

This device can be installed onto (interfaced with) backpack spray units, four wheeler spray units, as well as anything the “Mapper” is attached to.

It is highly desirable that the unit be small and light. The “Validator” could be used in conjunction with a “Sniper” to allow for the treatment of plants not previously treated (i.e. treatment applied if no previous treatment occurred). In other words allow the “Validator” to make some progress in the area of treating weeds for those instances where previous treatment was ineffective; either by being missed entirely or the previous treatment having been ineffective.

In an embodiment the validator module can record, but is not limited to, the following data: Location . . . keeps track of where the unit went (i.e. keeps track of where the “Validator” operator walked or took his four-wheeler or vehicle); Time and Date; Digital inputs—triggered check, selection/configuration of what is being validated (i.e. weed selection); Operator movement is recorded so that an area traversed can be recorded in the case that no weeds etc. remain to be noted.

It is very important that the operator conducting the validation does not activate the trigger in a location where there are no weeds (or whatever object) because the purpose is to identify only those objects that were untreated or appear to be untreated or that previous application was ineffective on. If this is not handled properly the validation results may not be accurate; misleading data was recorded.

In an embodiment the validator module can have, but is not limited to, the following indicators: Activated . . . “Validator” is recording; Battery voltage condition (green/red LED or meter); Trigger switch activation—red/green? indication when being fired; Trigger tone—acknowledgement of “activation and trigger”; Red/green environmental and occupational (political and job defined boundaries) zone control indicator (optional).

In an embodiment the validator module can have, but is not limited to, the following interfaces: Powered by vehicle power or battery power; Sprayer (replica or actual) handle. NOTE: Although it might not be as efficient, the identifying input does not have to be connected to a sprayer handle but can actually be provided via another source; GPS; Download to GIS and mapping systems; Other sensors/switches/indicators are built into the “Validator” kit; Touch screen interface; Keypad/trigger input (i.e. BLACKBERRY®/IPOD®/PALM PILOT® style interface); Digital inputs (unit selector/configurations/trigger etc.).

Another embodiment the Validator module can have, but is not limited to, the following configurations: Selection of the weed type(s) being treated (weeds list); Selection of the size of the weed being treated (rosette/mature) (weed size selector); Identification of trespass into environmental zones; controller for operation in defined environmental zones; Selection of the operator? LOGON/Operator Validation (allow the individual using the equipment to identify themselves); Validator list (i.e. backpack unit, four-wheeler unit, spotter, mapper, validator, etc.); Federal, State, County, Township, District, Individual (service provided by selector); Group selector—BLM, FS, F&G, etc., rancher, farmer, corporate, individual, volunteer, scientist (player selector); Generals (feds), colonels (states), captains (county extension), managers (field supervisors), contractors, private (management level validation selector).

Another embodiment the Validator module can be used for, but is not limited to, the following applications: Integrate into GIS systems—mapping and review systems—war-on-weeds type information access; Joint information between all of the various concerned groups: EPA, USDA, BLM, FS, F&G, Federal list, State list, County Extension Agents, private land owners, the Monsanto's of the world, scientists, field applicators, universities, weed management agencies, libraries, individuals, etc.; Joint information for Health and Human Services, environmental concerns, etc.—to provide joint cooperation between all affected groups; Data for the government and commercial scientists to analyze spray effectiveness of the various conditions in which the sprays were applied; Information for the workforce to enable them to demonstrate the work completed (accountability information); Determination of effectiveness of previous and continuous treatments. For example, if treatments are conducted over a number of years—are improvements being realized?

During operation the Validator automatically marks the location, with GPS accuracy, where and when a weed (or whatever) was observed. The Validator can perform calculations, such as, to help determine overall job performance and to perform compliance monitoring . . . assuming data is available from previous “Sniper” like activities.

The gathered information is stored and can then be downloaded for user access. Also the Validator can also be switched into “Spotter” mode.

For applications such as noxious weed control, extension, state, and federal agencies all conduct validation of treatments for weed infestations. This tool can benefit them by providing specific, recorded, and accurate information concerning the validation performed. Proof of validation is automated.

Efficiencies can be gained by communicating between the various users and operators who will conduct validation for the same project. This can help avoid duplication of validation efforts or, when desired, insure duplication of effort occurs.

The process of application, followed by validation, provides much information on the effectiveness of a previous treatment; especially when conducted over a number of years. Scientists and managers alike can benefit from this information. Task or job performance evaluations and analysis can be made using this product.

The Validator can function as a Sniper. This means that weeds can be sprayed at the same time the validation occurs. This tool, in conjunction with the Walker/Positioner” can allow the user to go directly to areas that need to be validated.

The Validator can keep track of who conducted the validation. The unit can also be configured to provide a substantial amount of information about the job/task, therefore, such things as: improved job analysis, reporting, and automated accounting and billing functions can be performed. It also insures Regulatory compliance and contract validation for payment.

As with the Sniper, each time the Validator is triggered accurate locations and computations such as: densities and acreage, as well as, mapping can be provided automatically. Further, the Validator, can be placed in “Spotter” mode, which allows for less accurate but visual validation.

The validation task is simplified because information is available from previous activities such as: “Sniper”, “Mapper”, “Spotter”, “Snipper” and “Validator” activities. This information can be used by the “Validator” to help make informed decisions on the areas that should be validated. The Validator can use the “Walker/Positioner” functionality to go to the areas that are to be validated.

The Snipper module is a user or operator configurable product used to keep track of manually and automatically triggered equipment for both personal and commercial devices such as carried devices: weed-eaters, leaf-blowers, and metal detectors, as well as walk behind equipments such as: lawn mowers, roto-tillers, snow blowers, sidewalk cleaners, and cement trowels. The Snipper product is aimed at individual and commercial use products that do not require governmental reporting; rather the reporting needs are aimed at more efficient business operations.

The “Snipper” is a proposed SOD device, very similar to the Sniper products, except that it is aimed at individual and commercial use products that do not require governmental reporting; rather the reporting needs are aimed at more efficient business operations. The automated recording of information for managers, customers, operators, individuals aimed at controlling, monitoring, and recording of manual and automatic triggered equipment and devices. For example, the “Snipper” is a device used to record trimming (weed-eating) in an intelligent manner.

This device can be installed onto (interfaced with) weed eaters, leaf blowers, snow blowers, lawn mowers, ATV's, roto-tillers (garden implements), fertilizers, and other lawn care applications etc.

It is highly desirable that the unit be small and light! If the operator is already carrying a weed eater, they don't want to have to carry anything more. A backpack unit is for monitoring the position of the man operating the equipment or device. Then connects to the device being triggered.

The “Snipper” is intended to eventually be incorporated onto a SOD devices enabling the automated movement of and providing the service of trimming, spraying, fertilizing etc. Notice that this device can also be incorporated into other automated devices, not just to manually operated devices.

The description of this product is indicative of other products this technology can be incorporated onto; such as, when an operator is using a leaf blower or other manually triggered yard equipment.

Another embodiment the Snipper module can record, but is not limited to, the following data: Location . . . keeps track of where the unit went (i.e. keeps track of where the “Snipper” operator ran the trimmer.); Time and Date; Ambient Temperature; Ambient Humidity; Rotational speed (optional); Battery voltages; Length of operation (how long was the unit triggered); Change in location of the weed eater head during triggering (i.e. size of patch being trimmed); Operational data (such as motor rotation, motor power, etc.)

Another embodiment the Snipper module can have, but is not limited to, the following indicators: Activated . . . “Snipper” is recording; Battery voltage condition; Trigger switch activation—red/green? indication when being fired; Trigger tone—acknowledgement of “activation and trigger”; Red/green occupational (job defined boundaries and specific locations) zone control indicator (optional).

Another embodiment the Snipper module can have, but is not limited to, the following interfaces: Powered by vehicle power or battery power; Trimmer handle; Digital inputs—NOTE: It is not necessary to trigger via input attached directly to the device trigger, the indicating input can be provided via another external source.; Rotational head monitoring; Time and date; GPS—location/speed; Download to GIS and mapping systems; Other sensors/switches/indicators are built into the “Snipper” kit; User Interface Module (display); User Interface Module (push button/keypad); Digital inputs—(selection/configuration and obstacle identification). These interfaces can also apply to other modules.

Another embodiment the Snipper module can have, but is not limited to, the following configurations: Identification of trespass out of defined work zones; controller for operation in defined work zones; Selection of the operator? LOGON/Operator Validation (allow the individual using the equipment to identify themselves); Snipper list (i.e. weed-eater brand, etc.); Corporate, Individual (service provided by selector); Generals (corporation), colonels (franchises/company), captains (location/branch), managers (field supervisors), contractors, private (management level validation selector), operators.

Another embodiment the Snipper module can be used in, but is not limited to, the following applications: Integrate into GIS systems—mapping and review systems; Joint information between all of the various concerned groups: corporate, franchise or company, location or branch, private land owners, individuals, operators, etc.; Information for the workforce to enable them to demonstrate the work completed (accountability information); Determination of effectiveness of previous and continuous treatments. For example, if treatments are conducted over a number of years—are improvements being realized?; Automated accounting and billing systems.

The automated recording of information for managers, customers, operators, and individuals aimed at controlling, monitoring, and recording of manual and automatic triggered equipment and devices. For example, the “Snipper” is a device used to record trimming (weed-eating) in an intelligent manner. Further “Snipper” can be interfaced with any kind of operated machinery or personal tool to provide collect data.

During operation the Snipper maintains operational information concerning the activation of the device such as: device triggering, duration of trigger, device activation, engine activation or blade rotation. The Snipper automatically gathers and maintains time, date, and location with GPS accuracy. The Snipper can also be used to validation of the coverage of areas or around obstacles such as the weed-eating along sidewalks and around trees. The gathered information is stored and can then be downloaded for user access. The Snipper can also be switched into “Spotter” mode.

The Snipper is useful in keeping track of where and when, say, a weed-eater was activated or operated. In this way, a record of each of the obstacles on a piece of property could be recorded and it could be determined if everything that was supposed to be trimmed actually was. It can also monitor area coverage such as lawn mowing operations and maintain this information for job statistics purposes.

For applications such as noxious weed control, the Snipper enables monitoring of the mechanical method chosen for weed control. While at the same time the operator is getting the work done.

The unit can also be configured to provide a substantial amount of information about the job/task, therefore, such things as: improved job analysis, reporting, and automated accounting and billing functions can be performed. Lawn care providers can benefit tremendously from this capability. A wide range of users can benefit from the gathered data. Operators, customers, and company managers for sure will all want access to the job statistics.

Each time the Snipper is triggered, accurate location information is captured, therefore, accurate locations, computations such as: coverage and acreage, as well as, mapping can be provided automatically.

The technology to develop the product(s) described in this document are readily available off-the-shelf; both in OEM computer equipment: devices, switches, wiring, components, as well as providers of devices such as PALM® type computer equipment such as: IPOD, BLACKBERRY®, BLACKJACK, ZUNE, PDA's, as well as cell phones. Many companies and individuals have already invested into these devices and they are small and light and are ideal candidates for use as the computer device (CPU) within some of our proposed configurations. It is desirable to use equipment the user already has access to; the final product configuration should incorporate as much existing technology as possible; assuming, of course, it is feasible.

The configurable GIS data system provides support for such things as implementation of noxious weed laws (the war-on-weeds) and EPA regulations. Herbicide, pesticide, etc. spray applications. It can be used with various other plant/weed/turf applications such as on orchards, vineyards, or any other crops. Lawn care (commercial and independent) users or Independent individuals and operators with benefit from the system. As well as those in compliance auditing, or contractor work validation.

In one embodiment, the products can be voice activated. Configuration and triggering of the unit's functionality can be conducted in this manner. This would allow the elimination of such things as switches and touch screen interfaces. Further the system can be configured to trigger upon any kind of user/operator generated signal.

Products could eventually control such factors as tank pressures etc.; initially it is expected that tank pressures will be set as they are on the products now. It could be used on spray or sponge type applicators. Units can be configured to provide multiple products/sprays to be delivered from one unit. The “Sniper” can attach to multiple devices; the same system can attach like plug and play devices to other equipment. This allows the unit to be used in the field as a “Sniper” or “Mapper”, or in a vehicle as a “Spotter”. In this way various attachment kits can be used for the particular application or job being done. The “Sniper” being separate and can go with whatever system you want, thus enabling the sharing of system expense over many tasks. Incorporation of a camera on the unit (especially to enhance the “Mapper” functionality) so that it can be confirmed using the photograph, and with time/date stamp, taken w/o going back out into the field to validate whether or not the plant (object/noxious weed) is what it was claimed to be. Communication between and coordination with other Sniper units (i.e. using technology such as MOTES). This will allow the coordination between individual operators to work better as a team. Contractor work validation for others such as for regulatory agencies.

Product configuration for most “kits” is required. However, a primary strategy behind this product line is to provide as much automation of the task as possible. The system can be use with a large range of applications to include, but not limited to, hazardous waste, litter, graffiti, fertilizer, lawn care, ranch applications, herbicide, pesticide, wild bird tracking, and wild animal tracking.

The system also can track various modes of conveyance to include, but not limited to, tracking on foot, 4 wheeler, ATV, hummer, helicopter, airplane, lawn mower, tiller, wind rower, tractor, farm implement, wheel loader, backhoe, scrapper, cement mixer, road grader, crane, military vehicle, tank, locomotive, dump truck, semi-truck, garbage truck, ambulance, and fire truck.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claim(s). For example, while the exemplary embodiments illustrate commercial or personal use, the invention is not limited to use with commercial or personal use and may be used with other military uses. While the invention is not limited to use with tooling used for various horticulture needs, it is expected that various embodiments of the invention will be particularly useful for such uses. Hence, the foregoing description should not be construed to limit the scope of the invention, which is defined in the following claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claim(s).

What is claimed is:

1. A configurable GIS data system, comprising: a means to spatially and temporally monitor personnel or material.
